(19) United States
(12) Patent Application Publication
(10) Pub. No.: US 2026/0119301 A1
(43) Pub. Date: Apr. 30, 2026

(54) DEVICE FOR PROCESSING LOG DATA, OPERATING METHOD THEREOF, AND SYSTEM INCLUDING THE DEVICE

(71) Applicant: SAMSUNG ELECTRONICS CO., LTD., Suwon-si (KR)

(72) Inventors: Jonghun Jeong, Suwon-si (KR); Sangho Yi, Suwon-si (KR); Chaehwan Yang, Suwon-si (KR); Kyounghweon Lee, Suwon-si (KR)

(21) Appl. No.: 19/003,856

(22) Filed: Dec. 27, 2024

(30) Foreign Application Priority Data
Jan. 8, 2024 (KR) 10-2024-0003111

(51) Int. Cl. G06F 11/07

(52) U.S. Cl. CPC G06F 11/0787; G06F 11/0727; G06F 11/0736; G06F 11/079

(57) ABSTRACT

A log processing device for processing log data, an operating method thereof, and a system including the log processing device are presented. The log processing device includes internal memory for storing log data and an internal processor for processing the log data. The operating method for processing the log data includes receiving the log data from at least one storage device, storing the received log data, generating failure analysis data by performing failure analysis on the log data, and transferring the failure analysis data to a host device.

### CROSS-REFERENCE TO RELATED APPLICATION

This application is based on and claims priority under 35 U.S.C. § 119 to Korean Patent Application No. 10-2024-0003111, filed on Jan. 8, 2024, in the Korean Intellectual Property Office, the disclosure of which is incorporated by reference herein in its entirety.

### BACKGROUND

The field of the technology relates to a processing device, and more particularly, to a device for processing log data, an operating method thereof, and a system including the device.

Semiconductor memory is divided into volatile memory of which stored data is lost when power supply is cut off, such as SRAM, DRAM, etc., and non-volatile memory that retains stored data even when power supply is cut off, such as flash memory, PRAM, MRAM, RRAM, FRAM, etc. A solid state drive (SSD) including non-volatile memory is used as a memory system in many electronic devices.

As storage systems become more integrated and miniaturized, failure analysis and prediction may become important and the importance of predictive maintenance using log data from storage devices may increase. However, the process of collecting and analyzing long-term log data places a large load on the existing host.

### SUMMARY

The disclosure describes a device for processing log data, an operating method thereof, and a system including the device.

According to examples, there is provided an operating method of a log processing device including internal memory for storing log data and an internal processor for processing the log data, the operating method including receiving the log data from at least one storage device, storing the received log data, generating failure analysis data by performing failure analysis on the log data, and transferring the failure analysis data to a host device.

According to other examples, there is provided a log processing device for processing log data, the log processing device including internal memory configured to store the log data received from at least one storage device, and an internal processor configured to perform failure analysis on the log data and generate failure analysis data, wherein the log processing device transfers the failure analysis data to a host device.

According to other examples, there is provided a system including at least one storage device for storing data, a host device, and a log processing device for processing log data, wherein the log processing device includes internal memory configured to store the log data received from at least one storage device and an internal processor configured to perform failure analysis on the log data and generate failure analysis data, and the log processing device transfers the failure analysis data to the host device.

### BRIEF DESCRIPTION OF THE DRAWINGS

Implementations will be more clearly understood from the following detailed description taken in conjunction with the accompanying drawings in which:

FIG. 1 is a block diagram of a host-storage system including a log processing device according to implementations;

FIG. 2 is a block diagram of a host-storage system including a log processing device according to implementations;

FIG. 3 is a flowchart of an operating method of a log processing device according to implementations;

FIG. 4 is a flowchart of an operating method of a log processing device according to implementations;

FIGS. 5A and 5B are detailed flowcharts of an operating method of a log processing device according to implementations;

FIG. 6 is a flowchart of an operating method of a log processing device according to implementations;

FIG. 7 is a flowchart of an operating method of a log processing device according to implementations;

FIG. 8 is a flowchart of an operating method of a log processing device according to implementations;

FIG. 9 is a flowchart of an operating method of a log processing device according to implementations;

FIG. 10 is a block diagram of a system to which a storage device according to implementations is applied;

FIG. 11 is a block diagram of a data center to which a storage device according to implementations is applied; and

FIG. 12 is a cross-sectional view of a BVNAND structure applicable to a storage device according to implementations.

### DETAILED DESCRIPTION

Hereinafter, implementations are described in detail with reference to the accompanying drawings.

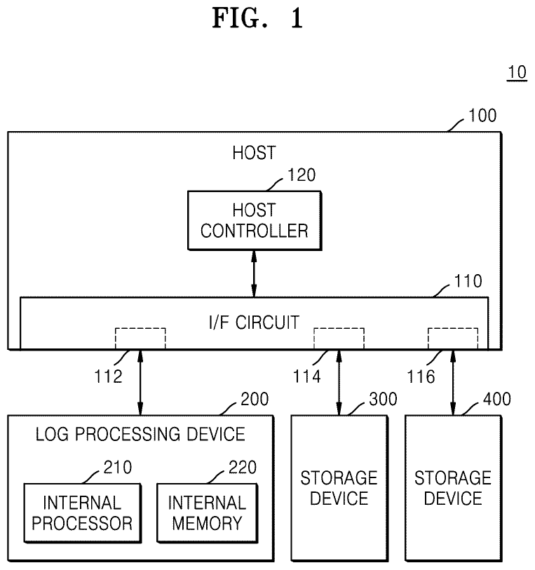

FIG. 1 is a block diagram of a host-storage system 10 including a log processing device 200 according to implementations.

Referring to FIG. 1, the host-storage system 10 may include a host 100, a log processing device 200, and at least one storage device 300 and 400. The host-storage system 10 is illustrated herein as including two storage devices, but this is only an example. The host-storage system 10 may include a different number of storage devices.

The host 100 may control data processing operations, for example, data read operations or data write operations, for at least one storage device 300 and 400. The host 100 may refer to a data processing device capable of processing data, such as a central processing unit (CPU), a processor, a microprocessor, or an application processor (AP). The host 100 may run an operating system (OS) and/or various applications. In an implementation, the host-storage system 10 may be included in a mobile device and the host 100 may be implemented as an AP. In some implementations, the host 100 may be implemented as a system-on-a-chip (SoC) and, accordingly, may be embedded in an electronic device.

The host 100 may include an interface circuit 110 and a host controller 120. Additionally, although not shown, the host 100 may additionally include host memory. The host controller 120 may be a device configured to control overall operations of the host 100 or control the at least one storage device 300 and 400 on the host 100 side. The host memory may function as buffer memory for temporarily storing data to be transferred to the at least one storage device 300 and 400 or data transferred from the at least one storage device 300 and 400.

The interface circuit 110 may provide an interface for exchanging data between the host 100, the at least one storage device 300 and 400, and the log processing device 200. For example, the interface circuit 110 may be implemented in various interface methods, such as peripheral component interconnect (PCI), PCI express (PCIe), and non-volatile memory express (NVMe). In some implementations, the interface circuit 110 may include a plurality of physical layers (PHYs) 112, 114, and 116. The PHYs 112, 114, and 116 may include physical components for exchanging data between the host 100, the at least one storage device 300 and 400, and the log processing device 200. Referring to FIG. 1, the host 100 and the log processing device 200 may be connected to each other through the PHY 112 of the interface circuit 110 to exchange data. Additionally, the at least one storage device 300 and 400 may be connected to the host 100 through the PHYs 114 and 116 of the interface circuit 110, respectively, to exchange data.

Additionally, the interface circuit 110 may provide an interface for exchanging data between a plurality of devices connected to the plurality of PHYs 112, 114, and 116. That is, the interface circuit 110 may provide an interface for supporting peer-to-peer (P2P) communication between a plurality of devices connected to the plurality of PHYs 112, 114, and 116. For example, the log processing device 200 connected to the PHY 112 may directly exchange data with the storage device 300 connected to the PHY 114 and the storage device 400 connected to the PHY 116 through the interface circuit 110.

P2P connection may enable the log processing device 200 to directly access data in the at least one storage device 300 and 400, thereby preserving the limited bandwidth in connection between the host 100 and the at least one storage device 300 and 400 and connection between the host 100 and the log processing device 200. Depending on implementation details, the P2P connection may increase the bandwidth or reduce the overhead, memory usage, and/or power consumption with respect to transferring data between the at least one storage device 300 and 400 and the log processing device 200, compared to transmitting data through the host 100 and/or host memory. In some implementations, the P2P connection may be particularly useful for shuffle acceleration operations, which may involve migrating data multiple times between the at least one storage device 300 and 400 and the log processing device 200.

The P2P connection may be implemented with any type of communication architecture and/or protocol, such as an interconnect, network, and/or storage interface. In some implementations, the P2P connection may be implemented in whole or in part as a separate logical or virtual connection on a shared physical connection that may be used to implement a communication interface.

The communication interface may be implemented with any type of communication architecture and/or protocol. For example, the communication interface may be implemented in whole or in part with an interconnection architecture and/or protocol, such as PCIe, compute express link (CXL), cache coherent interconnect for accelerators (CCIX), and the like. As another example, the communication interface may be implemented in whole or in part with a network architecture and/or protocol, such as Ethernet, TCP/IP, Fiber Channel (FC), InfiniBand, and the like. As an additional example, the communication interface may be implemented in whole or in part as a storage interface and/or protocol, such as serial advanced technology attachment (SATA), serial attached small computer small interface (SCSI) (SAS), NVMe, etc. Moreover, any of these architectures, protocols and/or interfaces may be combined in a hybrid combination, such as NVMe over Fabric (NVMe-oF).

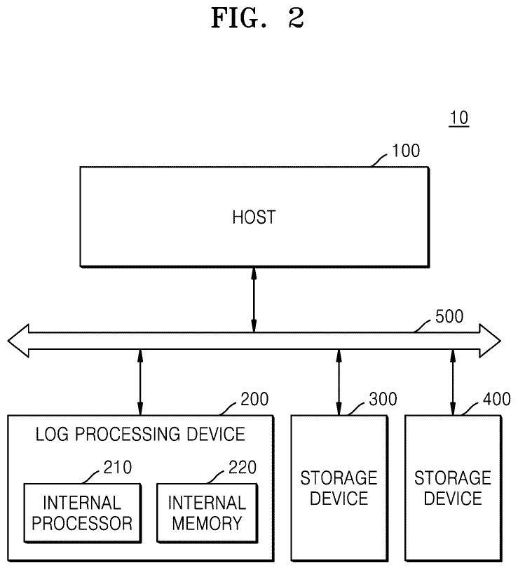

In addition, although the interface circuit 110 is shown as being included in the host 100 in FIG. 1, the interface circuit 110 may be a component that is distinct from the host 100. For example, as described below with reference to FIG. 2, the interface circuit 110 may be implemented in the form of a bus.

The at least one storage device 300 and 400, although not shown, may include a storage controller and non-volatile memory (NVM). The storage controller in the at least one storage device 300 and 400 may control the NVM to write data to the NVM in response to a write request from the host 100 or may control the NVM to read data stored in the NVM in response to a read request from the host 100.

The log processing device 200 may exchange data with the host 100 and the at least one storage device 300 and 400 and may process log data. The log processing device 200 may be connected to the PHY 112 of the interface circuit 110 to exchange data with the host 100. In addition, the log processing device 200 connected to the PHY 112 of the interface circuit 110 may exchange data with the at least one storage device 300 and 400 connected to the PHYs 114 and 116 through the P2P communication.

The log processing device 200 may include an internal processor 210 and internal memory 220. The log processing device 200 may receive log data from the at least one storage device 300 and 400. The log data may be data representing a status or a situation in the process of accessing a storage device. The log data may include data to determine the status of software, hardware, and infrastructure and may be in the form of telemetry data. The log data according to implementations may include the status of hardware, such as voltage, space, and memory usage thereof. Additionally, the log data according to implementations may include software error information. The log processing device 200 may receive log data from the at least one storage device 300 and 400 and may store the log data in the internal memory 220.

The internal processor 210 may perform failure analysis on the log data. The log data may be important in analysis to discover and remove failure factors that impede the productivity of the storage system. Since the log data generated from each semiconductor device may include a very large amount of data, not only is it difficult to analyze the log data generated from each semiconductor device in detail, but also it may take a very long time to analyze the log data. In addition, it is difficult to comprehensively compare and analyze each log data generated from each semiconductor device and to accurately analyze the correlation between each semiconductor device.

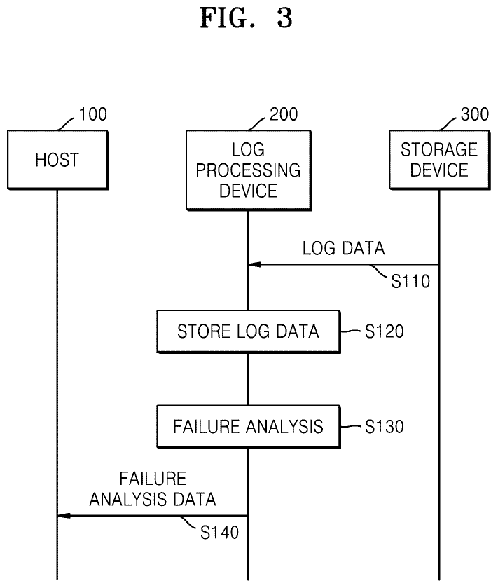

The internal processor 210 may download, compare, analyze, and convert a large amount of log data generated from the at least one storage device 300 and 400 into a database to generate data to improve productivity and product quality. In addition, the internal processor 210 may improve the operating efficiency of the storage system by comparing and analyzing the log data generated from the at least one storage device 300 and 400 and analyzing the correlation between the at least one storage device 300 and 400. The internal processor 210 may generate failure analysis data by performing failure analysis on the stored log data. The log processing device 200 may transfer the failure analysis data to the host 100. Hereinafter, the specific operating method of the log processing device 200 is described in detail below with reference to FIGS. 3 to 7.

For effective failure analysis of storage devices, relatively long-term log data of several months or more, rather than short-term log data, may be required. Additionally, the task of storing and analyzing a large amount of log data was not performed because excessive load may be caused when the task is performed by the existing host 100. According to the above-described implementation, the log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

FIG. 2 is a block diagram of a host-storage system including a log processing device according to implementations.

Referring to FIG. 2, the host-storage system 10 may include a host 100, a log processing device 200, at least one storage device 300 and 400, and a bus 500. The host-storage system 10 of FIG. 2 may be an example of the host-storage system 10 of FIG. 1. The host-storage system 10 is illustrated herein as including two storage devices, but this is only an example. The host-storage system 10 may include a different number of storage devices. Hereinafter, FIG. 2 is described with reference to FIG. 1 and overlapping descriptions with those described above are omitted.

The host 100 may include an interface circuit 110 and a host controller 120. Additionally, although not shown, the host 100 may additionally include host memory. The host 100 may control data processing operations, for example, data read operations or data write operations, for at least one storage device 300 and 400.

The log processing device 200 may include an internal processor 210 and internal memory 220. The log processing device 200 may exchange data with the host 100 and the at least one storage device 300 and 400 and may process log data.

The storage controller in the at least one storage device 300 and 400 may control the NVM to write data to the NVM in response to a write request from the host 100 or may control the NVM to read data stored in the NVM in response to a read request from the host 100.

The bus 500 may provide an interface for exchanging data between the host 100, the at least one storage device 300 and 400, and the log processing device 200. For example, the interface circuit 110 may be implemented in various interface methods, such as PCI, PCIe, and NVMe. The bus 500 according to implementations may provide an interface for exchanging data between the host 100, the at least one storage device 300 and 400, and the log processing device 200. For example, the host 100 and the log processing device 200 may be connected to each other through the bus 500 to exchange data. Additionally, the at least one storage device 300 and 400 may be connected to the host 100 through the bus 500 to exchange data.

The bus 500 may provide an interface for exchanging data between a plurality of connected devices. That is, the bus 500 may provide an interface for supporting P2P communication between a plurality of connected devices. For example, the log processing device 200 may directly exchange data with the storage device 300 through the bus 500. Additionally, the log processing device 200 may directly exchange data with the storage device 400 through the bus 500.

The bus 500 may correspond to the interface circuit 110 of FIG. 1. That is, in FIG. 2, the bus 500 is shown as a component that is distinct from the host 100, but the bus 500 may be included in the host 100. For example, as described above with reference to FIG. 1, the bus 500 may be implemented in the form of the interface circuit 110 and may be included in the host 100.

FIG. 3 is a flowchart of an operating method of the log processing device 200 according to implementations.

Referring to FIG. 3, the operating method of the log processing device 200 may include a plurality of operations S110 to S140. In FIG. 3, one storage device 300 among the at least one storage device 300 and 400 and the log processing device 200 are shown to exchange data but are not limited thereto. Hereinafter, FIG. 3 is described with reference to FIG. 1 and overlapping descriptions with those described above are omitted.

In operation S110, the log processing device 200 may receive log data from the storage device 300. The log data may be data representing a status or a situation in the process of accessing a storage device and may include a status of hardware, software error information, etc. In operation S120, the log processing device 200 may store the received log data. For example, the log processing device 200 may store the log data in the internal memory 220.

In operation S130, the log processing device 200 may perform failure analysis on the log data. The failure analysis may include analysis to discover and remove failure factors that impede the productivity of storage devices. The log processing device 200 according to implementations may perform failure analysis on the log data through the internal processor 210. The log processing device 200 may generate failure analysis data by performing failure analysis on the log data. In operation S140, the log processing device 200 may transfer the generated failure analysis data to the host 100.

The log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

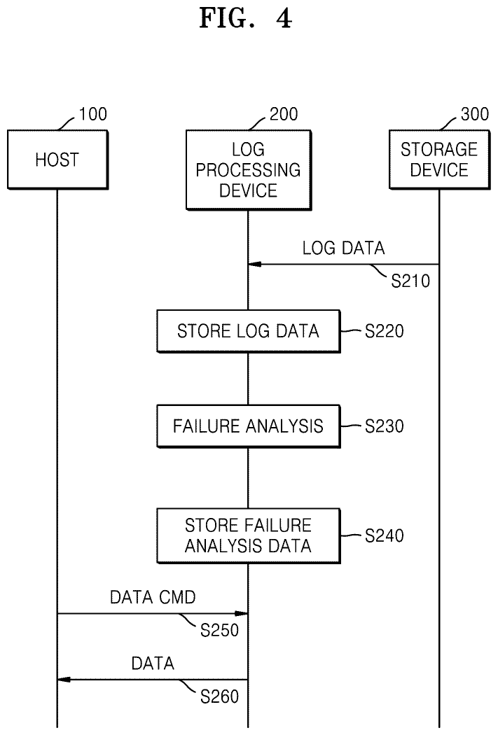

FIG. 4 is a flowchart of an operating method of a log processing device according to implementations.

Referring to FIG. 4, the operating method of the log processing device 200 may include a plurality of operations S210 to S260. In FIG. 4, one storage device 300 among the at least one storage device 300 and 400 and the log processing device 200 are shown to exchange data but are not limited thereto. Hereinafter, FIG. 4 is described with reference to FIGS. 1 and 3 and overlapping descriptions with those described above are omitted.

In operation S210, the log processing device 200 may receive log data from the storage device 300. In operation S220, the log processing device 200 may store the received log data. In operation S230, the log processing device 200 may perform failure analysis on the log data. Operations S210 to S230 may correspond to operations S110 to S130 of FIG. 3.

In operation S240, the log processing device 200 may store the generated failure analysis data. For example, the log processing device 200 may store the generated failure analysis data in the internal memory 220.

Additionally, in operation S250, the log processing device 200 may receive a data command from the host 100. For example, the data command may be a call request signal for the log data or a call request signal for the failure analysis data. The data command may be a call request signal for all the other types of data within the log processing device 200.

In operation S260, the log processing device 200 may transfer output data corresponding to the data command to the host 100. For example, when the data command is a call request signal for the log data, the output data may be the log data. Additionally, when the data command is a call request signal for the failure analysis data, the output data may be the failure analysis data.

Operations S250 and S260 may be performed prior to operations S230 and S240. For example, when the data command is a call request signal for the log data, operations S250 and S260 may be performed before failure analysis is performed on the log data received in operation S230. That is, before performing failure analysis on the log data, the log processing device 200 may receive a log data call request signal from the host 100 and transfer the log data to the host 100.

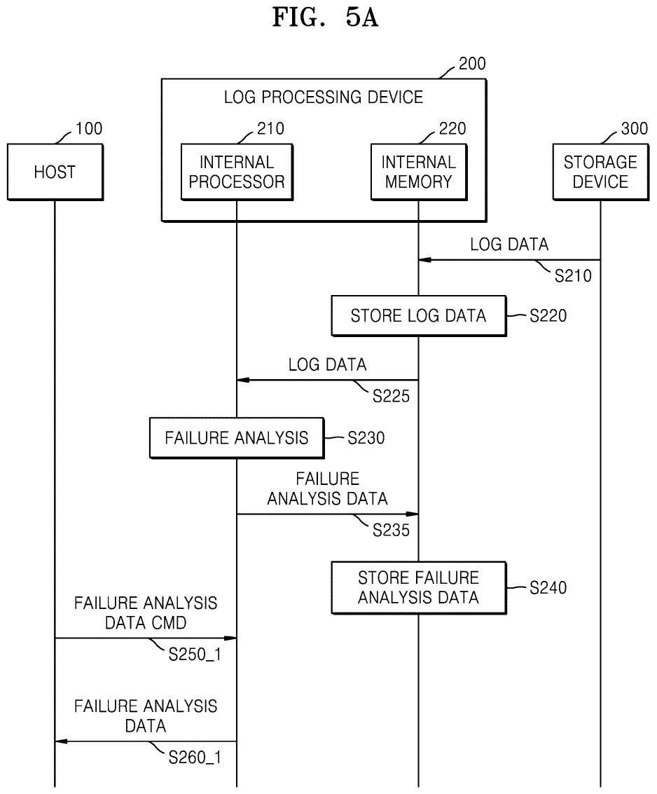

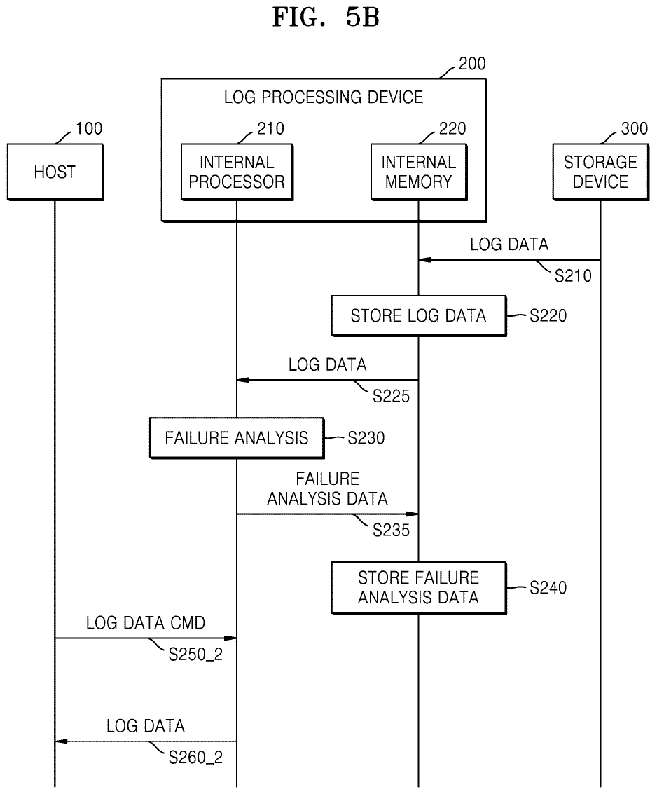

FIGS. 5A and 5B are detailed flowcharts of an operating method of a log processing device according to implementations.

Referring to FIGS. 5A and 5B, the operating method of the log processing device 200 may include a plurality of operations S210 to S260. In FIGS. 5A and 5B, one storage device 300 of the at least one storage device 300 and 400 and the log processing device 200 are shown to exchange data but are not limited thereto. Operations S210 to S240 may correspond to operations S110 to S140 of FIG. 3. Hereinafter, FIGS. 5A and 5B are described with reference to the above-described implementations and overlapping descriptions with those described above are omitted.

In operation S210, the log processing device 200 may receive log data from the storage device 300. In operation S220, the internal memory 220 of the log processing device 200 may store received log data. In operation S225, the internal processor 210 may receive the log data from the internal memory 220 in advance for failure analysis.

In operation S230, the internal processor 210 may perform failure analysis on the log data. The internal processor 210 may generate failure analysis data by performing failure analysis on the log data. In operation S235, the internal processor 210 may transfer the generated failure analysis data to the internal memory 220. In operation S240, the internal memory 220 may store the received failure analysis data.

In operation S250, the log processing device 200 may receive a data command from the host 100. For example, the data command may be a call request signal for the log data or a call request signal for the failure analysis data. The internal processor 210 may request data corresponding to the data command from the internal memory 220. The internal processor 210 may receive output data corresponding to the data command from the internal memory 220. For example, when the data command is a call request signal for the log data, the output data may be the log data. Additionally, when the data command is a call request signal for failure analysis data, the output data may be the failure analysis data. In operation S260, the log processing device 200 may transfer the output data corresponding to the data command to the host 100.

Referring to FIG. 5A, the log processing device 200 may receive a log data command from the host 100 in operation S250_1. In operation S260_1, the log processing device 200 may transfer the log data to the host 100. Operation S250_1 and operation S260_1 may be examples of operation S250 and operation S260.

Referring to FIG. 5B, in operation S250_2, the log processing device 200 may receive a failure analysis data command from the host 100. In operation S260_2, the log processing device 200 may transfer the failure analysis data to the host 100. Operation S250_2 and operation S260_2 may be examples of operation S250 and operation S260.

The log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

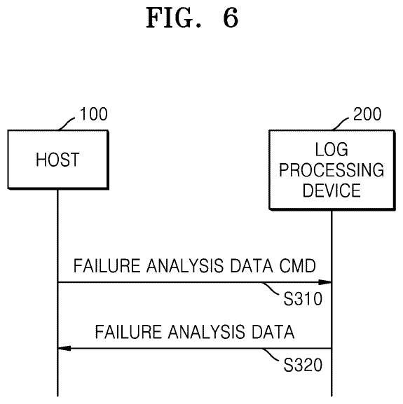

FIG. 6 is a flowchart of an operating method of a log processing device according to implementations.

Referring to FIG. 6, the operating method of the log processing device 200 may include a plurality of operations S310 to S320. Hereinafter, FIG. 6 is described with reference to the above-described implementations and overlapping descriptions with those described above are omitted.

In operation S310, the log processing device 200 may receive a failure analysis data command from the host 100. The log data command is a call request signal for the failure analysis data. Operation S310 may be an example of operation S250. In operation S320, the log processing device 200 may transmit the failure analysis data to the host 100. Operation S320 may be an example of operation S260.

Operations S310 and S320 may be performed independently of operations S210 to S260 described above. For example, operations S310 and S320 may be performed before failure analysis is performed on the log data received in operation S230. For example, before performing failure analysis on the log data, the log processing device 200 may receive a failure analysis data call request signal from the host 100 and may transfer the previously performed and stored analysis data to the host 100.

According to the above-described implementation, the log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

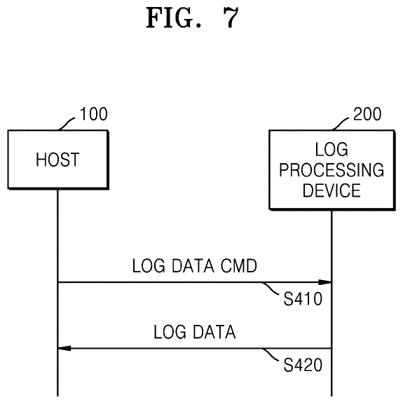

FIG. 7 is a flowchart of an operating method of a log processing device according to implementations.

Referring to FIG. 7, the operating method of the log processing device 200 may include a plurality of operations S410 to S420. Hereinafter, FIG. 7 is described with reference to the above-described implementations and overlapping descriptions with those described above are omitted.

In operation S410, the log processing device 200 may receive a log data command from the host 100. The log data command is a call request signal for the log data. Operation S310 may be an example of operation S250. In operation S420, the log processing device 200 may transmit log data to the host 100. Operation S420 may be an example of operation S260.

Operations S410 and S420 may be performed independently of operations S210 to S260 described above. For example, operations S410 and S420 may be performed before failure analysis is performed on the log data received in operation S230. For example, before performing failure analysis on the log data, the log processing device 200 may receive a log data call request signal from the host 100 and may transfer the log data to the host 100.

According to the above-described implementation, the log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

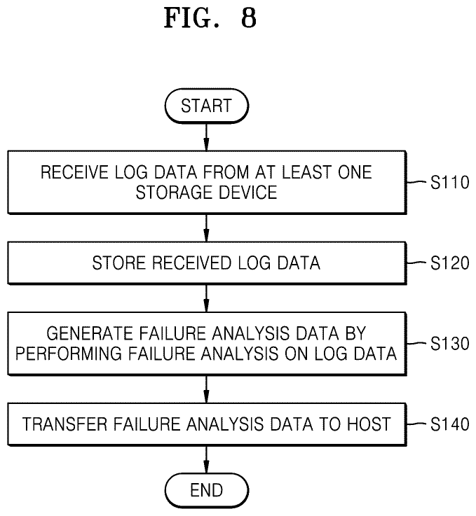

FIG. 8 is a flowchart of an operating method of a log processing device according to implementations.

Referring to FIG. 8, the operating method of the log processing device 200 may include a plurality of operations S110 to S140. Hereinafter, FIG. 8 is described with reference to FIGS. 1 and 3 and overlapping descriptions with those described above are omitted.

In operation S110, the log processing device 200 may receive log data from the storage device 300. The log data may be data representing a status or a situation in the process of accessing a storage device and may include a status of hardware, software error information, etc. In operation S120, the log processing device 200 may store the received log data. For example, the log processing device 200 may store the log data in the internal memory 220.

In operation S130, the log processing device 200 may perform failure analysis on the log data. The failure analysis may include analysis to discover and remove failure factors that impede the productivity of storage devices. The log processing device 200 according to implementations may perform failure analysis on the log data through the internal processor 210. The log processing device 200 may generate failure analysis data by performing failure analysis on the log data. In operation S140, the log processing device 200 may transfer the generated failure analysis data to the host 100.

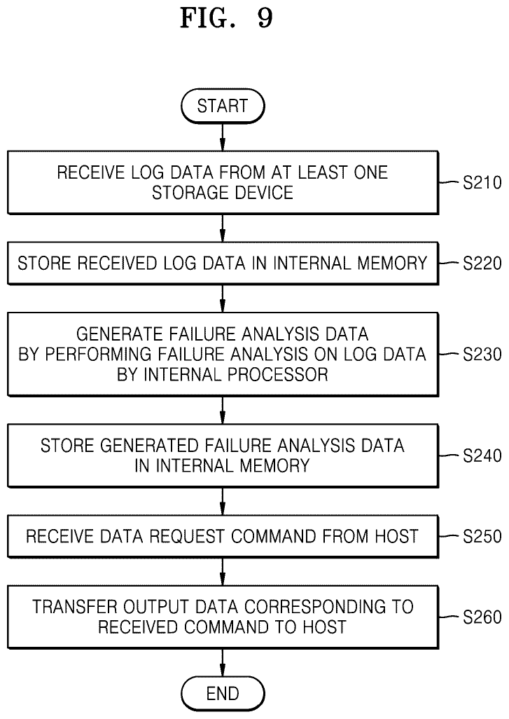

FIG. 9 is a flowchart of an operating method of a log processing device according to implementations.

Referring to FIG. 9, the operating method of the log processing device 200 may include a plurality of operations S210 to S260. Hereinafter, FIG. 9 is described with reference to the above-described implementations and overlapping descriptions with those described above are omitted.

In operation S210, the log processing device 200 may receive log data from the storage device 300. In operation S220, the log processing device 200 may store the received log data. In operation S230, the log processing device 200 may perform failure analysis on the log data. Operations S210 to S230 may correspond to operations S110 to S130 of FIG. 8.

In operation S240, the log processing device 200 may store the generated failure analysis data. For example, the log processing device 200 may store the generated failure analysis data in the internal memory 220.

In operation S250, the log processing device 200 may receive a data command from the host 100. For example, the data command may be a call request signal for the log data or a call request signal for the failure analysis data.

In operation S260, the log processing device 200 may transmit output data corresponding to the data command to the host 100. For example, when the data command is a call request signal for the log data, the output data may be the log data. Additionally, when the data command is a call request signal for the failure analysis data, the output data may be the failure analysis data.

Operations S250 and S260 may be performed prior to operations S230 and S240. For example, when the data command is a call request signal for the log data, operations S250 and S260 may be performed before failure analysis is performed on the log data received in operation S230. That is, before performing failure analysis on the log data, the log processing device 200 may receive a log data call request signal from the host 100 and transmit the log data to the host 100.

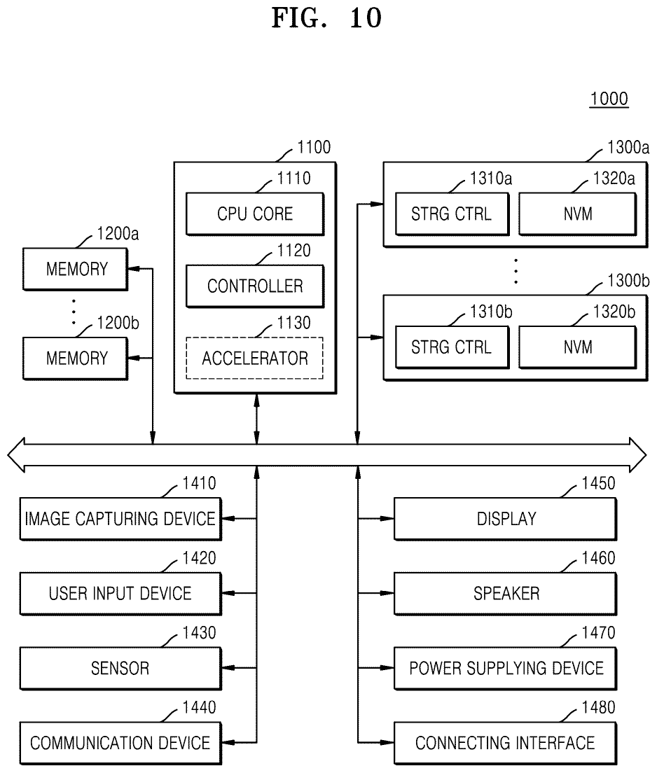

FIG. 10 is a block diagram of a system to which a storage device according to implementations is applied.

A system 1000 of FIG. 10 may be a mobile system, such as a mobile phone, a smartphone, a tablet personal computer (PC), a wearable device, a health-care device, or Internet of Things (IoT). However, the system 1000 of FIG. 10 is not necessarily limited to the mobile system. The system 1000 may include a personal computer, a laptop computer, a server, a media player, or an automotive device, such as a navigation system.

Referring to FIG. 10, the system 1000 may include a main processor 1100, memory 1200a and 1200b, and storage devices 1300a and 1300b. The system 1000 may additionally include one or more of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and more specifically, the operation of other components forming the system 1000. This main processor 1100 may be implemented as a general-purpose processor, a dedicated processor, or an AP.

The main processor 1100 may include one or more CPU cores 1110 and may further include a controller 1120 for controlling the memory 1200a and 1200b and/or the storage devices 1300a and 1300b. Depending on an implementation, the main processor 1100 may further include an accelerator block 1130, which is a dedicated circuit for high-speed data computation, such as artificial intelligence (AI) data computation. This accelerator block 1130 may include a graphics processing unit (GPU), a neural processing unit (NPU), and/or a data processing unit (DPU) and may be implemented as a separate chip that is physically independent from other components of the main processor 1100.

The memory 1200a and 1200b may be used as main memory devices of the system 1000. The memory 1200a and 1200b may include volatile memory, such as static random-access memory (SRAM) and/or dynamic random-access memory (DRAM), and may also include NVM, such as flash memory, phase-change memory (PRAM) and/or resistive random-access memory (RRAM). The memory 1200a and 1200b may also be implemented in the same package as the main processor 1100.

The storage devices 1300a and 1300b may function as non-volatile storage devices that store data regardless of whether power is supplied and may have a relatively large storage capacity, compared to the memory 1200a and 1200b. The storage devices 1300a and 1300b may include storage controllers 1310a and 1310b and NVM 1320a and 1320b that stores data under the control by the storage controllers 1310a and 1310b. The NVM 1320a and 1320b may include V-NAND flash memory with a 2-dimensional (2D) structure or a 3-dimensional (3D) structure but may also include other types of NVM, such as PRAM and/or RRAM.

In the system 1000, the storage devices 1300a and 1300b may be physically separate from the main processor 1100 or may be implemented in the same package as the main processor 1100. In addition, since the storage devices 1300a and 1300b have the same form as a solid state device (SSD) or a memory card, the storage devices 1300a and 1300b may be detachably coupled to other components of the system 1000 through an interface, such as a connecting interface 1480, which is described below. The storage devices 1300a and 1300b may be devices to which standard protocols, such as universal flash storage (UFS), embedded multi-media card (eMMC), or NVMe, are applied, but are not necessarily limited thereto.

The image capturing device 1410 may capture still images or moving images and may include a camera, a camcorder, and/or a webcam.

The user input device 1420 may receive various types of data input from the user of the system 1000 and may include a touchpad, a keypad, a keyboard, a mouse, and/or a microphone.

The sensor 1430 may detect various types of physical quantities obtained from outside the system 1000 and may convert the sensed physical quantities into electrical signals. The sensor 1430 may include a temperature sensor, a pressure sensor, an illumination sensor, a position sensor, an acceleration sensor, a bio-sensor, and/or a gyroscope.

The communication device 1440 may exchange signals with other devices outside the system 1000 according to various communication protocols. The communication device 1440 may be implemented including an antenna, a transceiver, and/or a modem.

The display 1450 and the speaker 1460 may function as output devices that output visual information and auditory information, respectively, to the user of the system 1000.

The power supplying device 1470 may appropriately convert power supplied from a battery (not shown) built into the system 1000 and/or an external power source and may supply the same to each component of the system 1000.

The connecting interface 1480 may provide a connection between the system 1000 and an external device that is connected to the system 1000 to exchange data with the system 1000. The connection interface 1480 may be implemented in various interface methods, such as ATA, SATA, external SATA (e-SATA), SCSI, SAS, PCI, PCIe, NVMe, IEEE 1394, universal serial bus (USB), secure digital (SD) card, multi-media card (MMC), eMMC, UFS, embedded UFS (eUFS), and compact flash (CF) card interface.

The system 1000 may additionally include the log processing device 200 described above. The log processing device 200 included in the system 1000 may collect log data of the storage devices 1300a and 1300b and perform failure analysis on the log data. The log processing device 200 may transfer failure analysis data to the main processor 1100. According to the above-described implementation, the log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

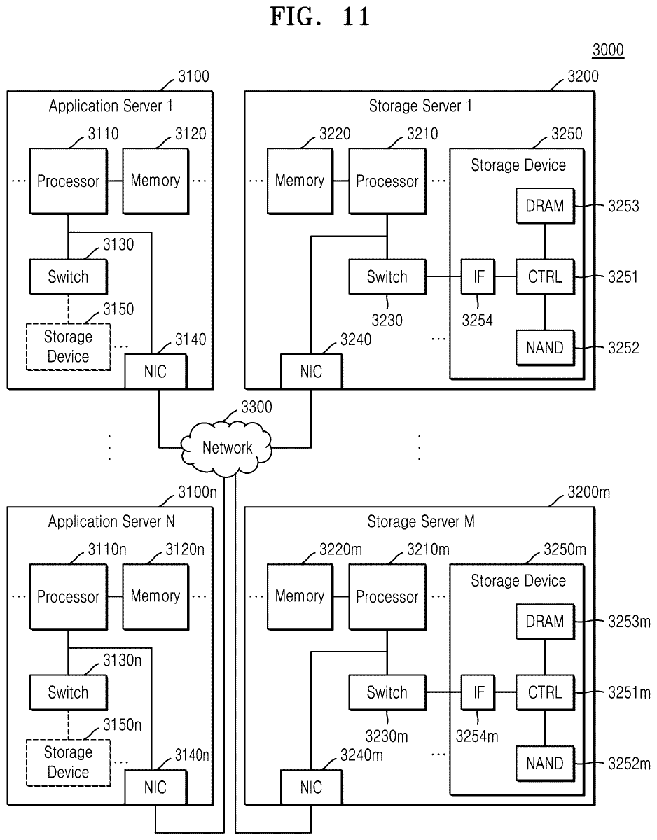

FIG. 11 is a block diagram of a data center to which a storage device according to implementations is applied.

Referring to FIG. 11, the data center 3000 which is a facility that collects various types of data and provides services may also be referred to as a data storage center. The data center 3000 may be a system for operating a search engine and a database or may be a computing system used in companies, such as banks or government agencies. The data center 3000 may include application servers 3100 to 3100n and storage servers 3200 to 3200m. The number of application servers 3100 to 3100n and the number of storage servers 3200 to 3200m may be selected in various ways depending on an implementation. In addition, the number of application servers 3100 to 3100n may be different from the number of storage servers 3200 to 3200m.

The application server 3100 or the storage server 3200 may include at least one of the processor 3110 and 3210 and the memory 3120 and 3220. For the storage server 3200, the processor 3210 may control the overall operation of the storage server 3200, access the memory 3220, and execute instructions and/or data loaded into the memory 3220. The memory 3220 may be double data rate synchronous DRAM (DDR SDRAM), high bandwidth memory (HBM), hybrid memory cube (HMC), dual in-line memory module (DIMM), Optane DIMM, or non-volatile DIMM (NVDIMM). Depending on an implementation, the number of processors 3210 and memories 3220 included in the storage server 3200 may be selected in various ways. In an implementation, the processor 3210 and the memory 3220 may provide a processor-memory pair. In an implementation, the number of processors 3210 may be different from the number of memories 3220. The processor 3210 may include a single core processor or a multi-core processor. The above description of the storage server 3200 may be similarly applied to the application server 3100. Depending on an implementation, the application server 3100 may not include a storage device 3150. The storage server 3200 may include at least one or more storage devices 3250. The number of storage devices 3250 included in the storage server 3200 may be selected in various ways depending on an implementation.

The application servers 3100 to 3100n may communicate with the storage servers 3200 to 3200m through a network 3300. The network 3300 may be implemented using FC or Ethernet. The FC, which is a medium used for relatively high-speed data transmission, may use an optical switch that provides high performance/high availability. Depending on the access method of the network 3300, the storage servers 3200 to 3200m may provide file storage, block storage, or object storage.

In an implementation, the network 3300 may be a storage-only network, such as a storage area network (SAN). For example, the SAN may be an FC-SAN that uses an FC network and is implemented according to the FC protocol (FCP). As another example, the SAN may be an IP-SAN that uses a TCP/IP network and is implemented according to the SCSI over TCP/IP or Internet SCSI (iSCSI) protocol. In another implementation, the network 3300 may be a general network, such as a TCP/IP network. For example, the network 3300 may be implemented according to protocols, such as FC over Ethernet (FCoE), network attached storage (NAS), and NVMe-oF.

Hereinafter, the description focuses on the application server 3100 and the storage server 3200. The description of the application server 3100 may also be applied to another application server 3100n and the description of the storage server 3200 may also be applied to another storage server 3200m.

The application server 3100 may store data requested by a user or a client to be stored in one of the storage servers 3200 to 3200m through the network 3300. Additionally, the application server 3100 may obtain data requested to be read by a user or a client from one of the storage servers 3200 to 3200m through the network 3300. For example, the application server 3100 may be implemented as a web server or a database management system (DBMS).

The application server 3100 may access memory 3120n or a storage device 3150n included in another application server 3100n through the network 3300 or may access memory 3220 to 3220m or storage devices 3250 to 3250m included in the storage servers 3200 to 3200m through the network 3300. Accordingly, the application server 3100 may perform various operations on data stored in the application servers 3100 to 3100n and/or the storage servers 3200 to 3200m. For example, the application server 3100 may execute a command to move or copy data between the application servers 3100 to 3100n and/or the storage servers 3200 to 3200m. The data may move from the storage devices 3250 to 3250m of the storage servers 3200 to 3200m to the memory 3120 to 3120n directly or through the memory 3220 to 3220m of the storage servers 3200 to 3200m. The data moving through the network 3300 may be encrypted data for security or privacy.

For the storage server 3200, an interface 3254 may provide a physical connection between the processor 3210 and a controller 3251 and a physical connection between an NIC 3240 and the controller 3251. For example, the interface 3254 may be implemented in a direct attached storage (DAS) method that directly connects the storage device 3250 to a dedicated cable. In addition, for example, the interface 3254 may be implemented in various interface methods, such as ATA, SATA, e-SATA, SCSI, SAS, PCI, PCIe, NVMe, IEEE 1394, USB, SD card, MMC, eMMC, UFS, eUFS, and CF card interface.

The storage server 3200 may further include a switch 3230 and the NIC 3240. The switch 3230 may selectively connect the processor 3210 to the storage device 3250 or may selectively connect the NIC 3240 to the storage device 3250 under the control by the processor 3210.

In an implementation, the NIC 3240 may include a network interface card, network adapter, and the like. The NIC 3240 may be connected to the network 3300 by a wired interface, a wireless interface, a Bluetooth interface, an optical interface, etc. The NIC 3240 may include internal memory, DSP, and a host bus interface and may be connected to the processor 3210 and/or the switch 3230 through a host bus interface. The host bus interface may be implemented as one of the examples of the interface 3254 described above. In an implementation, the NIC 3240 may be integrated with at least one of the processor 3210, the switch 3230, and the storage device 3250.

In the storage servers 3200 to 3200m or the application servers 3100 to 3100n, the processor 3210 may send commands to the storage devices 3150 to 3150n and 3250 to 3250m or the memory 3120 to 3120n and 3220 to 3220m to program or read data. The data may be error-corrected data through an error correction code (ECC) engine. The data may be data that has undergone data bus inversion (DBI) or data masking (DM) and may include cyclic redundancy code (CRC) information. The data may be encrypted data for security or privacy.

The storage devices 3150 to 3150n and 3250 to 3250m may transfer control signals and command/address signals to NAND flash memory devices 3252 to 3252m in response to read commands received from the processor 3210. Accordingly, when reading data from the NAND flash memory devices 3252 to 3252m, the read enable (RE) signal may be input as a data output control signal and may output data to a DQ bus. Data strobe (DQS) may be generated using the RE signal. The command and address signals may be latched in the page buffer depending on the rising edge or falling edge of the write enable (WE) signal.

The controller 3251 may generally control the operation of the storage device 3250. In an implementation, the controller 3251 may include SRAM. The controller 3251 may write data to the NAND flash memory device 3252 in response to write commands or may read data from the NAND flash memory device 3252 in response to read commands. For example, the write commands and/or read commands may be provided from the processor 3210 in the storage server 3200, the processor 3210m in another storage server 3200m, or the processors 3110 and 3110n in the application servers 3100 and 3100n. DRAM 3253 may temporarily buffer data to be written to the NAND flash memory device 3252 or data read from the NAND flash memory device 3252. Additionally, the DRAM 3253 may store metadata. The metadata is data generated by the controller 3251 to manage the user data or the NAND flash memory device 3252. The storage device 3250 may include a secure element (SE) for security or privacy.

The storage servers 3200 to 3200m or the application servers 3100 to 3100n may additionally include the above-described log processing device 200 therein. The log processing device 200 may collect log data from the storage devices 3150 to 3150m and 3250 to 3250m and perform failure analysis. The log processing device 200 may transfer failure analysis data to the processor 3210 in the storage server 3200, the processor 3210m in another storage server 3200m, or the processors 3110 and 3110n in the application servers 3100 and 3100n. According to the above-described implementation, the log processing device 200 may directly collect and store log data through P2P communication with the at least one storage device 300 and 400 and may perform failure analysis on its own since the log processing device 200 is separate from the host 100 and the at least one storage device 300 and 400, thereby minimizing the load on the host 100.

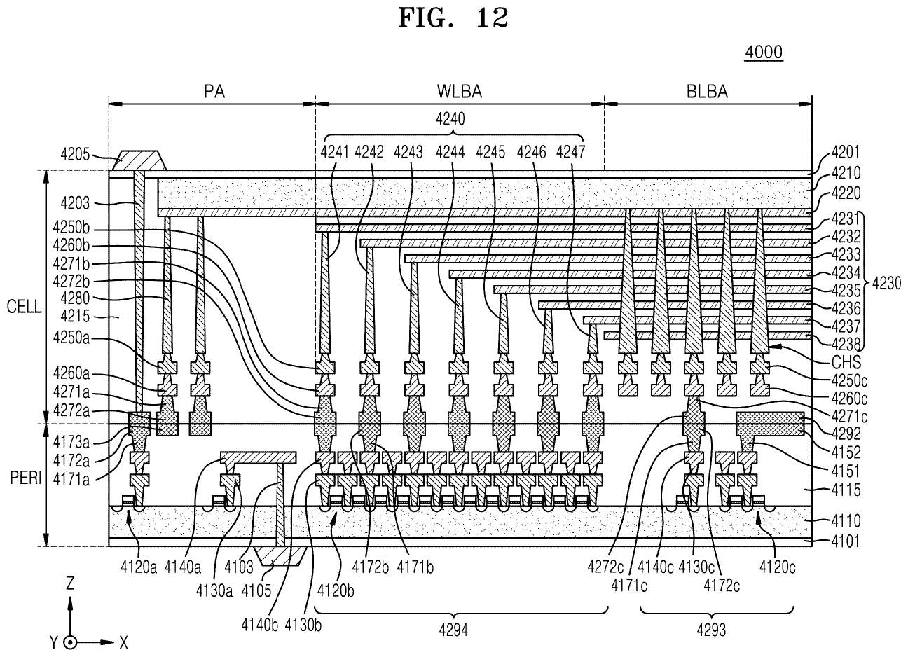

FIG. 12 is a cross-sectional view of a BVNAND structure applicable to a storage device according to implementations.

Referring to FIG. 12, a memory device 4000 may have a chip to chip (C2C) structure. The C2C structure may be obtained by manufacturing an upper chip including a cell area CELL on a first wafer, manufacturing a lower chip including a peripheral area PERI on a second wafer different from the first wafer, and connecting the upper chip to the lower chip by using a bonding method. For example, the bonding method may refer to a method of electrically connecting the bonding metal formed on the top metal layer of the upper chip and the bonding metal formed on the top metal layer of the lower chip. For example, when the bonding metal is formed of copper (Cu), the bonding method may be a Cu—Cu bonding method. In addition, the bonding metal may also be formed of aluminum or tungsten.

Each of the peripheral circuit area PERI and the cell area CELL of the memory device 4000 may include an external pad bonding area PA, a word line bonding area WLBA, and a bit line bonding area BLBA.

The peripheral circuit area PERI may include a first substrate 4110, an interlayer insulating layer 4115, a plurality of circuit elements 4120a, 4120b, and 4120c formed on the first substrate 4110, first metal layers 4130a, 4130b, and 4130c connected to the plurality of circuit elements 4120a, 4120b, and 4120c, respectively, and second metal layers 4140a, 4140b, and 4140c formed on the first metal layers 4130a, 4130b, and 4130c. In an implementation, the first metal layers 4130a, 4130b, and 4130c may be formed of tungsten with relatively high resistance and the second metal layers 4140a, 4140b, and 4140c may be formed of copper with relatively low resistance.

Only the first metal layers 4130a, 4130b, and 4130c and the second metal layers 4140a, 4140b, and 4140c are shown and described herein, but the metal layers are not limited thereto. At least one or more metal layers may be further formed on the second metal layers 4140a, 4140b, and 4140c. At least some of the one or more metal layers formed on top of the second metal layers 4140a, 4140b, and 4140c may be formed of aluminum which has a higher bulk resistivity than copper forming the second metal layers 4140a, 4140b, and 4140c.

The interlayer insulating layer 4115 may be formed on the first substrate 4110 to cover the plurality of circuit elements 4120a, 4120b, and 4120c, the first metal layers 4130a, 4130b, and 4130c, and the second metal layers 4140a, 4140b, and 4140c and may include an insulating material, such as silicon oxide, silicon nitride, etc.

Lower bonding metals 4171b and 4172b may be formed on the second metal layer 4140b in the word line bonding area WLBA. In the word line bonding area WLBA, the lower bonding metals 4171b and 4172b of the peripheral circuit area PERI may be electrically connected to the upper bonding metals 4271b and 4272b of the cell area CELL by a bonding method. The lower bonding metals 4171b and 4172b and the upper bonding metals 4271b and 4272b may be formed of aluminum, copper, or tungsten.

The cell area CELL may provide at least one memory block. The cell area CELL may include a second substrate 4210 and a common source line 4220. On the second substrate 4210, a plurality of word lines 4230 (4231 to 4238) may be stacked in a direction (Z-axis direction) perpendicular to the top surface of the second substrate 4210. String select lines and a ground select line may be positioned above and below each of the word lines 4230. The plurality of word lines 4230 may be positioned between the string select lines and the ground select line.

In the bit line bonding area BLBA, the channel structure CHS may extend in a direction perpendicular to the top surface of the second substrate 4210 and may extend through the word lines 4230, the string select lines, and the ground select line. The channel structure CHS may include a data storage layer, a channel layer, and a buried insulating layer, wherein the channel layer may be electrically connected to a first metal layer 4250c and a second metal layer 4260c. For example, the first metal layer 4250c may be a bit line contact and the second metal layer 4260c may be a bit line. In implementations, the bit line 4260c may extend in a first direction (Y-axis direction) parallel to the top surface of the second substrate 4210.

In an implementation shown in FIG. 12, the area where the channel structure CHS and the bit line 4260c are placed may be defined as the bit line bonding area BLBA. The bit line 4260c may be electrically connected to the circuit elements 4120c that provide a page buffer 4293 in the bit line bonding area BLBA in the peripheral circuit area PERI. For example, the bit line 4260c may be connected to upper bonding metals 4271c and 4272c in the peripheral circuit area PERI, wherein the upper bonding metals 4271c and 4272c may be connected to lower bonding metals 4171c and 4172c connected to the circuit elements 4120c of the page buffer 4293.

In the word line bonding area WLBA, the word lines 4230 may extend in a second direction (X-axis direction) parallel to the top surface of the second substrate 4210 and may be connected to a plurality of cell contact plugs 4240 (4241 to 4247). The word lines 4230 may be connected to the cell contact plugs 4240 at pads provided by at least some of the word lines 4230 extending to different lengths in the second direction. A first metal layer 4250b and a second metal layer 4260b may be sequentially connected to the top of the cell contact plugs 4240 connected to the word lines 4230. The cell contact plugs 4240 may be connected to the peripheral circuit area PERI through the upper bonding metals 4271b and 4272b of the cell area CELL and the lower bonding metals 4171b and 4172b of the peripheral circuit area PERI in the word line bonding area WLBA.

The cell contact plugs 4240 may be electrically connected to the circuit elements 4120b that provide a row decoder 4294 in the peripheral circuit area PERI. In implementations, the operating voltage of the circuit elements 4120b providing the row decoder 4294 may be different from the operating voltage of the circuit elements 4120c providing the page buffer 4293. For example, the operating voltage of the circuit elements 4120c that provide the page buffer 4293 may be greater than the operating voltage of the circuit elements 4120b that provide the row decoder 4294.

A common source line contact plug 4280 may be positioned in the external pad bonding area PA. The common source line contact plug 4280 may be made of a conductive material, such as metal, metal compound, or polysilicon, and may be electrically connected to the common source line 4220. A first metal layer 4250a and a second metal layer 4260a may be sequentially stacked on the common source line contact plug 4280. For example, the area where the common source line contact plug 4280, the first metal layer 4250a, and the second metal layer 4260a are positioned may be defined as the external pad bonding area PA.

Meanwhile, input/output pads 4105 and 4205 may be positioned in the external pad bonding area PA. Referring to FIG. 12, a lower insulating film 4101 may be formed below the first substrate 4110 to cover the bottom surface of the first substrate 4110. The first input/output pad 4105 may be formed on the lower insulating film 4101. The first input/output pad 4105 may be connected to at least one of the plurality of circuit elements 4120a, 4120b, and 4120c positioned in the peripheral circuit area PERI through the first input/output contact plug 4103 and may be separated from the first substrate 4110 by the lower insulating film 4101. Additionally, a side insulating film may be positioned between the first input/output contact plug 4103 and the first substrate 4110 to electrically separate the first input/output contact plug 4103 from the first substrate 4110.

Referring to FIG. 12, an upper insulating film 4201 may be formed on the second substrate 4210 to cover the top surface of the second substrate 4210. The second input/output pad 4205 may be disposed on the upper insulating film 4201. The second input/output pad 4205 may be connected to at least one of the plurality of circuit elements 4120a, 4120b, and 4120c positioned in the peripheral circuit area PERI through the second input/output contact plug 4203.

Depending on an implementation, the second substrate 4210 and the common source line 4220 may not be positioned in the area where the second input/output contact plug 4203 is positioned. Additionally, the second input/output pad 4205 may not overlap with the word lines 4230 in the third direction (Z-axis direction). Referring to FIG. 10, the second input/output contact plug 4203 may be separated from the second substrate 4210 in a direction parallel to the top surface of the second substrate 4210 and may be connected to the second input/output pad 4205 by passing through the interlayer insulating layer 4215 in the cell area CELL.

Depending on implementations, the first input/output pad 4105 and the second input/output pad 4205 may be formed selectively. For example, the memory device 4000 may include only the first input/output pad 4105 disposed on the top of the first substrate 4110 or may include only the second input/output pad 4205 disposed on the top of the second substrate 4210. Alternatively, the memory device 4000 may include both the first input/output pad 4105 and the second input/output pad 4205.

In the external pad bonding area PA and the bit line bonding area BLBA included in each of the cell area CELL and the peripheral circuit area PERI, the metal pattern of the top metal layer may exist as a dummy pattern or the top metal layer may be empty.

In the external pad bonding area PA, in response to the upper metal pattern 4272a formed on the top metal layer of the cell area CELL, the memory device 4000 may form a lower metal pattern 4173a of the same shape as the upper metal pattern 4272a of the cell area CELL on the top metal layer of the peripheral circuit area PERI. The lower metal pattern 4173a formed on the top metal layer of the peripheral circuit area PERI may not be connected to a separate contact in the peripheral circuit area PERI. Similarly, in response to the lower metal pattern formed on the top metal layer of the peripheral circuit area PERI in the external pad bonding area PA, the memory device 4000 may form the upper metal pattern of the same shape as the lower metal pattern of the peripheral circuit area PERI on the top metal layer.

The lower bonding metals 4171b and 4172b may be formed on the second metal layer 4140b of the word line bonding area WLBA. In the word line bonding area WLBA, the lower bonding metals 4171b and 4172b of the peripheral circuit area PERI may be electrically connected to the upper bonding metals 4271b and 4272b of the cell area CELL by a bonding method.

Additionally, in the bit line bonding area BLBA, in response to the lower metal pattern 4152 formed on the top metal layer of the peripheral circuit area PERI, an upper metal pattern 4292 having the same shape as the lower metal pattern 4152 of the peripheral circuit area PERI may be formed on the top metal layer of the cell area CELL. A contact may not be formed on the upper metal pattern 4292 formed on the top metal layer of the cell area CELL.

The memory device 4000 of FIG. 12 may correspond to the NVM inside the at least one storage device 300 and 400 described above. Additionally, the memory device 4000 may correspond to at least some of the various types of memory or memory devices described above.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the device has been particularly shown and described with reference to implementations thereof, it will be understood that various changes in form and details may be made therein without departing from the spirit and scope of the following claims.

What is claimed is:

1. An operating method of a log processing device comprising internal memory for storing log data and an internal processor for processing the log data, the operating method comprising:
receiving the log data from at least one storage device;
storing the received log data;
generating failure analysis data by performing failure analysis on the log data; and
transferring the failure analysis data to a host device.

2. The operating method of claim 1, further comprising:
receiving a data command from the host device; and
transferring output data corresponding to the data command to the host device.

3. The operating method of claim 2, wherein the data command comprises a call request signal for the log data, and the output data comprises the log data.

4. The operating method of claim 2, wherein the data command comprises a call request signal for the failure analysis data, and the output data comprises the failure analysis data.

5. The operating method of claim 1, further comprising storing the failure analysis data in the internal memory.

6. The operating method of claim 1, wherein the log processing device performs peer-to-peer communication with the at least one storage device.

7. The operating method of claim 6, wherein the peer-to-peer communication is based on a peripheral component interconnect express communication method.

8. The operating method of claim 1, wherein the log processing device is connected to the host device through a physical terminal.

9. A log processing device for processing log data, the log processing device comprising:
internal memory configured to store the log data received from at least one storage device; and
an internal processor configured to perform failure analysis on the log data and generate failure analysis data,
wherein the log processing device transfers the failure analysis data to a host device.

10. The log processing device of claim 9, wherein the log processing device receives a data command from the host device and transfers output data corresponding to the data command to the host device.

11. The log processing device of claim 10, wherein the data command comprises a call request signal for the log data, and the output data comprises the log data.

12. The log processing device of claim 10, wherein the data command comprises a call request signal for the failure analysis data, and the output data comprises the failure analysis data.

13. The log processing device of claim 9, wherein the internal memory is configured to store the failure analysis data.

14. The log processing device of claim 9, wherein the log processing device performs peer-to-peer communication with the at least one storage device.

15. The log processing device of claim 14, wherein the peer-to-peer communication is based on a peripheral component interconnect express communication method.

16. The log processing device of claim 9, wherein the log processing device is connected to the host device through a physical terminal.

17. A system comprising:
at least one storage device for storing data;
a host device; and
a log processing device for processing log data,
wherein the log processing device comprises internal memory configured to store the log data received from the at least one storage device, and an internal processor configured to perform failure analysis on the log data and generate failure analysis data, and
the log processing device transfers the failure analysis data to the host device.

18. The system of claim 17, wherein the log processing device receives a data command from the host device and transfers output data corresponding to the data command to the host device.

19. The system of claim 17, wherein the log processing device performs peer-to-peer communication with the at least one storage device.

20. The system of claim 17, wherein the log processing device is connected to the host device through a physical terminal.
